(19) United States
(12) Patent Application Publication
(10) Pub. No.: US 2026/0126379 A1
(43) Pub. Date: May 7, 2026

(54) SPECTROMETRY DEVICE

(71) Applicant: Hitachi High-Tech Corporation, Tokyo (JP)

(72) Inventors: Kaifeng ZHANG, Tokyo (JP); Masahiro WATANABE, Tokyo (JP); Takenori HIROSE, Tokyo (JP)

(21) Appl. No.: 19/118,210

(22) PCT Filed: Sep. 27, 2023
(86) PCT No.: PCT/JP2023/035091

§ 371 Date: Apr. 3, 2025

(30) Foreign Application Priority Data
Dec. 28, 2022 (JP) 2022-211533

(51) Int. Cl. G01N 21/3563; G01N 21/65

(52) U.S. Cl. CPC G01N 21/3563; G01N 21/65

(57) ABSTRACT

A spectrometry device simultaneously performs an infrared spectroscopic analysis and a Raman spectroscopic analysis on a sample that cannot be exposed to the atmosphere with high spatial resolution. The spectrometry device includes electromagnetic wave sources that generate first and second electromagnetic waves. The second electromagnetic wave has a wavelength shorter than the first electromagnetic wave. An optical system focusses the first and second electromagnetic waves on the sample. An electromagnetic wave having the same wavelength as the second electromagnetic wave is detected by a first detector and an electromagnetic wave having a different wavelength is detected by a second detector, among electromagnetic waves generated by reflection or scattering of the second electromagnetic wave by the sample. A control device performs a first analysis based on a detection signal of the first detector and a second analysis based on a detection signal of the second detector.

### TECHNICAL FIELD

The present invention relates to a spectrometry device.

### BACKGROUND ART

A spectrometry device is a device that analyzes a composition of a substance or identifies a foreign substance mixed in the substance by measuring an absorption curve specific to the substance with respect to a wavelength of light, that is, an absorption spectrum. Since infrared light having a wavelength around 10 times that of visible light is generally used for analysis of molecular vibration or the like, spatial resolution limited by a diffraction limit which is proportional to a wavelength of used light is limited to the order of 10 μm.

PTL 1 discloses an observation device including an ultraviolet, visible, and infrared spectroscopy unit that acquires an absorption spectrum via a common microscope optical system and a Raman spectroscopy unit that acquires a Raman spectrum.

### CITATION LIST

### Patent Literature

PTL 1: JP2017-49611A

### SUMMARY OF INVENTION

### Technical Problem

The ultraviolet, visible, and infrared spectroscopy unit in PTL 1 generates a two-dimensional spectroscopic image by introducing ultraviolet, visible, or infrared light transmitted through an observation sample, and obtains an absorption spectrum from the two-dimensional spectroscopic image. Therefore, spatial resolution of a spectrometry device, in particular, infrared spectrometry, disclosed in PTL 1 is low.

The inventors have developed a spectrometry device capable of simultaneously achieving infrared spectrometry and Raman spectrometry with high spatial resolution by using probe light having a short wavelength. In general, a spectrometry device performs measurement in an atmospheric environment, but there is also a need for observation of a sample that cannot be exposed to, for example, the atmosphere, which is an observation application that is not disclosed in the related art, by utilizing high spatial resolution. For example, in research and development of an electrode material, a catalyst, and the like of a lithium ion battery, there is a need to observe a change in a material caused by an electrochemical action during charging and discharging of a battery under an operation state of the battery. In-situ spectrometry for such a battery material cannot be performed in an atmospheric environment.

### Solution to Problem

A spectrometry device according to an embodiment of the invention includes: a stage configured to allow a sample to be placed; a first electromagnetic wave source configured to generate a first electromagnetic wave; a second electromagnetic wave source configured to generate a second electromagnetic wave having a wavelength shorter than the first electromagnetic wave; an optical system including an objective lens configured to focus the first electromagnetic wave and the second electromagnetic wave on the sample; a first detection unit configured to detect an electromagnetic wave having the same wavelength as the second electromagnetic wave and a second detection unit configured to detect an electromagnetic wave having a different wavelength from the second electromagnetic wave, among electromagnetic waves generated by reflection or scattering of the second electromagnetic wave by the sample; a cell configured to separate the sample from an atmospheric environment to allow the sample to be placed on the stage; and a control device configured to perform a first analysis based on a detection signal of the first detection unit and a second analysis based on a detection signal of the second detection unit.

### Advantageous Effects of Invention

It is possible to provide a spectrometry device capable of simultaneously performing an infrared spectroscopic analysis and a Raman spectroscopic analysis on a sample that cannot be exposed to the atmosphere with high spatial resolution. Problems, configurations, and effects other than those described above will be clarified by description of the following embodiments.

### BRIEF DESCRIPTION OF DRAWINGS

FIG. 1 is a schematic configuration diagram showing an example of a spectrometry device.

FIG. 2 is a diagram showing an energy beam and probe light emitted to a sample.

FIG. 3A shows a configuration of a confocal detector.

FIG. 3B is a diagram showing a relationship between a detection light amount of the confocal detector and a displacement amount.

FIG. 4A is a diagram showing a relationship between detection light amounts of two confocal detectors and a displacement amount.

FIG. 4B is a diagram showing a relationship between a sum of the detection light amounts of the two confocal detectors and the displacement amount.

FIG. 4C is a diagram showing a relationship between the displacement amount and a ratio of a difference to the sum of the detection light amounts of the two confocal detectors.

FIG. 5A is a view showing an internal structure of an electrochemical cell.

FIG. 5B is a view showing an internal structure of the electrochemical cell.

FIG. 6A shows an example in which an aberration correction plate is provided in an optical system of the spectrometry device.

FIG. 6B shows an example in which the aberration correction plate is provided in an optical system of the spectrometry device.

### DESCRIPTION OF EMBODIMENTS

Hereinafter, an embodiment of a spectrometry device according to the invention will be described with reference to the drawings.

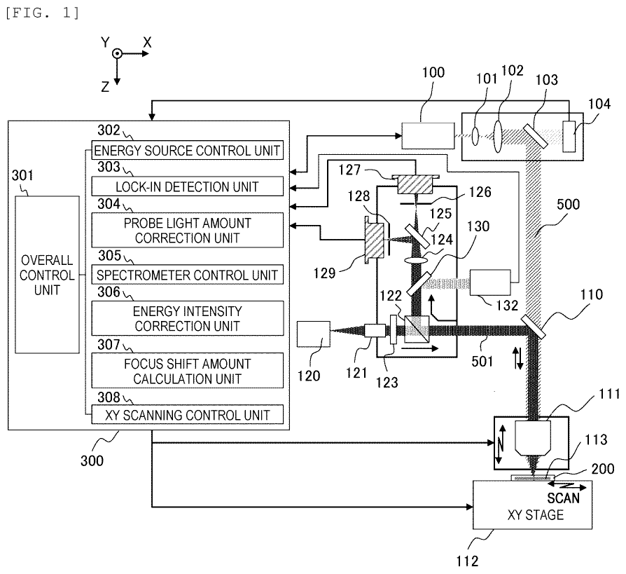

An overall configuration of a spectrometry device according to the embodiment will be described with reference to FIG. 1. In FIG. 1, a vertical direction is a Z direction, and horizontal directions are an X direction and a Y direction. The spectrometry device includes a stage mechanism system in which a sample 113 is provided, an energy application system that applies energy to the sample 113, a measurement system that measures a physical property value of the sample 113, and a control system that processes data output from each unit and controls each unit.

The stage mechanism system includes an XY stage 112 on which the sample 113 is placed and that is moved in the X direction and the Y direction. Any region of a surface of the sample 113 is analyzed by moving the XY stage 112 in the X direction and the Y direction. The sample 113 is placed in a cell 200 and is isolated from the atmospheric environment.

The energy application system includes an energy source 100, beam expander lenses 101 and 102, a partial reflection mirror 103, an energy detector 104, a dichroic mirror 110, and an objective lens 111. The dichroic mirror 110 and the objective lens 111 in an optical system of the energy application system are shared with an optical system of the measurement system.

The energy source 100 generates an energy beam 500, for example, infrared light, for applying energy to the sample 113. After a beam diameter of the energy beam 500 is expanded by the beam expander lenses 101 and 102, the energy beam 500 travels toward the partial reflection mirror 103. The partial reflection mirror 103 transmits a part of the energy beam 500 toward the energy detector 104 and reflects the remaining energy beam 500 toward the sample 113. The energy detector 104 measures an intensity of the energy beam 500 transmitted through the partial reflection mirror 103. The energy beam 500 reflected by the partial reflection mirror 103 is transmitted through the dichroic mirror 110, is focused by the objective lens 111, and is emitted to the sample 113. The sample 113 irradiated with the energy beam 500 absorbs the applied energy to cause physical and chemical property changes, thermal expansion, a refractive index change, a magnetic property change, and the like.

The measurement system includes a light source 120, a collimator lens 121, a beam splitter 122, a wavelength filter 123, a condensing lens 124, a half mirror 125, a dichroic mirror 130, pinholes 126 and 128, light detectors 127 and 129, a spectrometer 132, the dichroic mirror 110, and the objective lens 111.

The light source 120 generates probe light 501, for example, visible light or ultraviolet light which is an electromagnetic wave, for measuring the above-described changes of the sample 113 caused by the energy application by the energy beam 500. It is desirable that the probe light 501 generated by the light source 120 has a wavelength shorter than that of the energy beam 500 and is condensed into a smaller spot. The probe light 501 is converted into a substantially parallel beam by the collimator lens 121, is transmitted through the wavelength filter 123 and the beam splitter 122, and travels toward the dichroic mirror 110. The dichroic mirror 110 reflects the probe light 501 toward the objective lens 111. The probe light 501 reflected by the dichroic mirror 110 is focused by the objective lens 111 and is emitted to the sample 113.

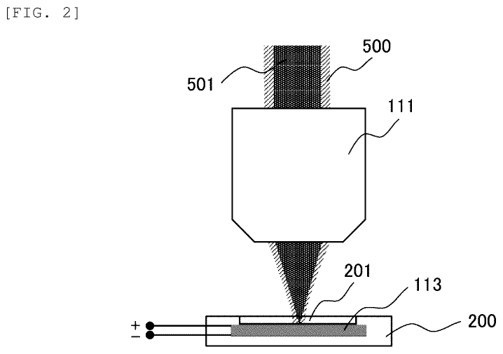

The energy beam 500 and the probe light 501 emitted to the sample 113 will be described with reference to FIG. 2. As described above, both the energy beam 500 and the probe light 501 are focused by the objective lens 111 and are emitted to the sample 113. The probe light 501 has a beam diameter smaller than that of the energy beam 500, and is emitted onto a region narrower than a region irradiated with the energy beam 500, and by detecting reflected light or scattered light of the probe light 501, a change in the region irradiated with the energy beam 500 can be measured with high spatial resolution. For example, when the probe light 501 is visible light having a wavelength of 632 nm and NA of the objective lens is 0.8, a beam diameter of the probe light 501 focused on the surface of the sample 113 is about 0.95 μm, and in the case of a general optical microscope, spatial resolution of the measurement system is smaller than half the beam diameter, that is, smaller than 0.495. In the embodiment, a confocal detector is further used in the measurement system, so that the spatial resolution of the measurement system can be further reduced. A physical property value to be measured includes a change in displacement or curvature of the surface of the sample 113 that expands due to absorption of the energy beam 500, a change in surface reflectance, and the like.

Here, an example in which the sample 113 is a battery material is shown, and the sample 113 is sealed in the cell 200 in order to enable In-situ measurement. The energy beam 500 and the probe light 501 are transmitted through an observation window 201 provided in the cell 200 and are emitted to the sample (battery material) 113. A structure of the cell 200 will be described later.

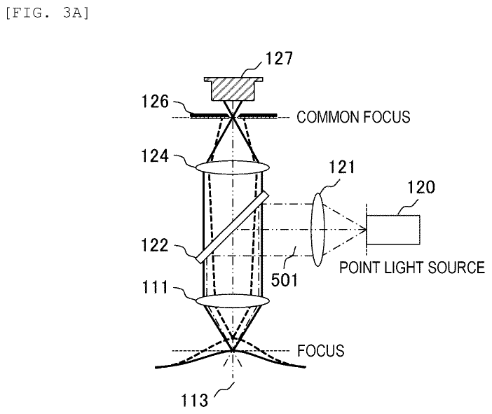

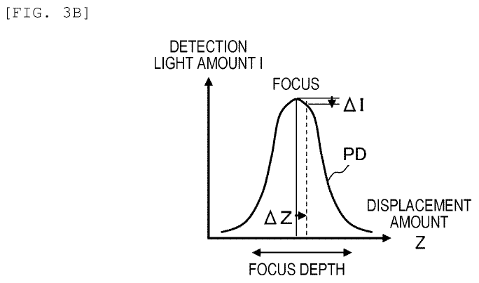

The confocal detector will be described with reference to FIG. 3A and FIG. 3B. The confocal detector is configured such that, when light emitted from a point light source is focused on a surface of a sample, light reflected or scattered from the sample (hereinafter, referred to as reflection without distinction unless otherwise specified) is focused on a detection surface. Specifically, the light source 120, the collimator lens 121, the beam splitter 122, the objective lens 111, the sample 113, the condensing lens 124, the pinhole 126, and the light detector 127 are arranged as shown in FIG. 3A. The probe light 501 generated by the point light source of the light source 120 is collimated by the collimator lens 121, then is reflected by the beam splitter 122, and is incident on the objective lens 111. The objective lens 111 focuses the probe light 501.

When the focus is on the surface of the sample 113, the probe light 501 reflected by the sample 113 passes through the objective lens 111, the beam splitter 122, and the condensing lens 124 on an optical path indicated by solid lines in FIG. 3A, and is focused at the pinhole 126. As a result, most of the probe light 501 reflected by the sample surface passes through the pinhole 126 and is detected by the light detector 127. On the other hand, when the sample 113 is expanded due to the irradiation of the energy beam 500 and the surface is displaced as indicated by a dotted line in FIG. 3A, the probe light 501 reflected by the sample 113 travels along an optical path indicated by dotted lines and is not focused at the pinhole 126. As a result, an amount of light that passes through the pinhole 126 and is detected by the light detector 127 is smaller than that in the case of the optical path indicated by the solid line. That is, since a detection light amount of the light detector 127 changes according to a displacement amount of the surface of the sample 113, a change in a physical property value of the sample 113 to which energy is applied can be measured by the light detector 127.

FIG. 3B is a graph (detection light amount curve PD) showing a relationship between a detection light amount I of the confocal detector and a displacement amount Z of the sample. As shown in FIG. 3B, the detection light amount I becomes maximum when the sample surface is at a focusing position, and decreases as the sample surface deviates from the focusing position. However, detection sensitivity of a displacement amount shown as an absolute value of a ratio ΔI/ΔZ of a change amount ΔI of the detection light amount I to a change amount ΔZ of the displacement amount Z is minimum at the focusing position, and is substantially zero in the vicinity of the focusing position. Therefore, in the configuration example shown in FIG. 1, the detection sensitivity is improved by using detection signals from two confocal detectors in a detection unit (first detection unit) that detects the probe light 501 reflected by the sample 113. Although a case where the surface displacement of the sample 113 occurs has been described above, for example, when a refractive index of the sample 113 is changed due to the irradiation of the energy beam 500 as well, a change degree can also be detected by a change in the detection light amount I.

As shown in FIG. 1, the probe light 501 reflected by the surface of the sample 113 returns to the beam splitter 122 on an original optical path and is reflected toward the condensing lens 124. The probe light 501 incident on the condensing lens 124 is condensed and travels to the half mirror 125. The half mirror 125 transmits approximately half of the condensed probe light 501 toward the pinhole 126, and the remaining approximately half of the probe light 501 is reflected toward the pinhole 128. Of the probe light 501 transmitted through the half mirror 125, the probe light 501 passed through the pinhole 126 is detected by the light detector 127. Of the probe light 501 reflected by the half mirror 125, the probe light 501 passed through the pinhole 128 is detected by the light detector 129. Here, the pinhole 126 and the pinhole 128 are arranged so as to deviate from a focus position of the condensing lens 124. That is, the pinhole 126 is arranged away from the focus position of the condensing lens 124 by a distance L in a direction away from the sample 113, and the pinhole 128 is arranged away from the focus position by the distance L in a direction toward the sample 113. The distance L is set to be equal to or less than a focus depth.

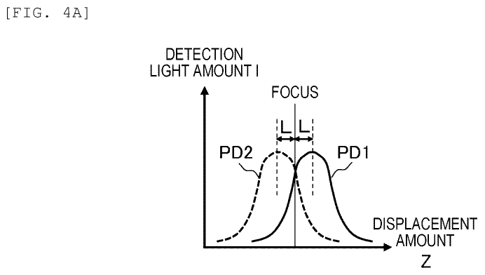

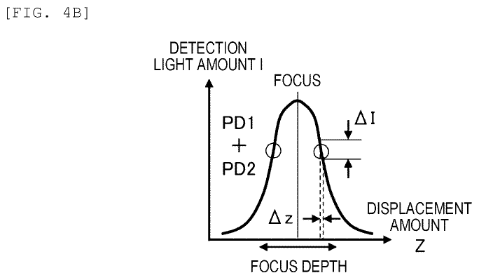

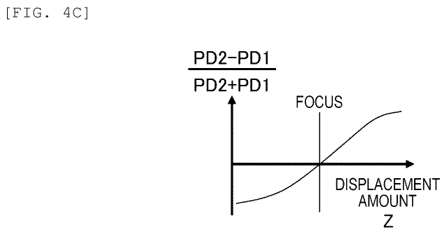

FIG. 4A is a graph showing a relationship between detection light amounts of the light detector 127 and the light detector 129 and a displacement amount of the sample 113 when the pinhole 126 and the pinhole 128 are each arranged apart from the focus position by the distance L. A peak of a detection light amount curve PD1 of the light detector 127 and a peak of a detection light amount curve PD2 of the light detector 129 are deviated from a focusing position by the distance L in opposite directions.

FIG. 4B is a graph obtained by adding the detection light amount curve PD1 and the detection light amount curve PD2. By using the graph shown in FIG. 4B, the displacement amount can be measured at a position where the detection sensitivity of the displacement amount that is an absolute value of ΔI/ΔZ is high, for example, positions indicated by circles in FIG. 4B. That is, the detection sensitivity of the displacement amount can be improved.

FIG. 4C is a graph calculated using Formula 1.

$$( PD 2 - PD 1 ) / ( PD 2 + PD 1 ) \qquad ( Formula 1 )$$

A value calculated by Formula 1 changes substantially in a linear manner with respect to the displacement amount Z and becomes zero at the focusing position. Therefore, control for adjusting a focus position is facilitated by using the graph shown in FIG. 4C. For example, by controlling a position of the sample 113 in the Z direction so that the value of (Formula 1) becomes zero, it is possible to absorb deviation of the focus position caused by drift of a distance between the objective lens 111 and the sample 113. In addition, measurement can be performed while making the focus position to follow unevenness of the surface of the sample 113.

A value used for controlling the focus position may be (PD2−PD1). When (PD2−PD1) is used, there is no division of (Formula 1), and a calculation amount can be reduced, so that a processing time can be shortened. On the other hand, when Formula 1 is used, since normalization is performed using (PD2+PD1), even when reflectance or a refractive index of the surface of the sample 113 is not uniform or the intensity of the light source 120 fluctuates, the influence thereof can be prevented.

Further, in the configuration example shown in FIG. 1, the dichroic mirror 130 is disposed between the beam splitter 122 and the condensing lens 124, and the probe light 501 reflected by the surface of the sample 113 is separated by the dichroic mirror 130 into a partial light component having a wavelength different from the original wavelength. Light reflected or elastically scattered by the surface of the sample 113 is transmitted through the dichroic mirror 130 and is incident on the condensing lens 124. On the other hand, the spectrometer 132 can acquire a Raman spectrum by setting a wavelength of light reflected by the dichroic mirror 130 and incident on the spectrometer 132 to include a wavelength region of Raman scattered light emitted when the probe light 501 is incident on the sample 113.

The wavelength filter 123 may be added between the dichroic mirror 110 and the beam splitter 122. Detection noises can be reduced by preventing detection of light having a wavelength that causes noises.

Next, the control system will be described. The control system is a control device 300 including an overall control unit 301, an energy source control unit 302, a lock-in detection unit 303, a probe light amount correction unit 304, a spectrometer control unit 305, an energy intensity correction unit 306, a focus shift amount calculation unit 307, and an XY scanning control unit 308. The overall control unit 301 is an arithmetic unit that controls each unit and processes and transmits data generated by each unit, and is a central processing unit (CPU), a micro processing unit (MPU), or the like. Each unit other than the overall control unit 301 may be implemented by dedicated hardware using an application specific integrated circuit (ASIC), a field-programmable gate array (FPGA), or the like, or may be implemented by software operating on an arithmetic unit. The control device 300 includes a storage device that stores a program and data for performing control or processing, and is connected to an output device such as a display device and a printer and an input device such as a keyboard or a pointing device.

The energy source control unit 302 controls a wavelength, an intensity, and the like of the energy beam 500 generated by the energy source 100. An absorption spectrum of the sample 113 can be measured by performing scanning using the wavelength. In addition, by modulating the intensity, the lock-in detection unit 303 can perform lock-in detection, which will be described later.

The lock-in detection unit 303 performs so-called lock-in detection by detecting the detection light amounts PD1 and PD2 of the light detectors 127 and 129 while comparing the detection light amounts PD1 and PD2 with a modulation signal transmitted from the energy source control unit 302. For example, an amplitude of (PD2−PD1) is obtained by lock-in detection of a signal of (PD2−PD1) with reference to a modulation signal.

The lock-in detection may be performed on each of the detection light amount PD1 and the detection light amount PD2 with reference to the modulation signal, and then a difference between the two detection light amounts may be calculated, or the lock-in detection may be performed on the value of Formula 1.

Instead of the lock-in detection, so-called AM detection may be used in which a displacement signal corresponding to a modulation frequency of the energy beam 500 is extracted by a filter and then an amplitude is measured. An intensity of a spectrum peak corresponding to the modulation frequency may be measured by performing a spectrum analysis on the displacement signal using FFT or the like. Further, other general amplitude detection methods may be used.

The probe light amount correction unit 304 divides the amplitude of (PD2−PD1) obtained by the lock-in detection unit 303 by (PD2+PD1). Since a value obtained by the division is proportional to an amplitude of the displacement of the surface of the sample 113, the value may be referred to as a sample displacement measurement value.

The spectrometer control unit 305 executes parameter adjustment and detection signal collection of the spectrometer 132.

The energy intensity correction unit 306 calculates a value in proportional to an energy absorption rate by normalizing the sample displacement measurement value obtained by the probe light amount correction unit 304 with an intensity of the energy beam 500 measured by the energy detector 104. An absorption spectrum of the sample 113 is obtained by calculating a value in proportional to the energy absorption rate while performing scanning using a wavelength of the energy beam 500.

The focus shift amount calculation unit 307 controls a position of the objective lens 111 in the Z direction based on the value of Formula 1. By controlling the position of the objective lens 111 in the Z direction, the probe light 501 can follow the unevenness of the surface of the sample 113. That is, by using two confocal detectors, autofocus can be achieved without separately providing an autofocus mechanism, and space saving of the device can be achieved.

The XY scanning control unit 308 moves the objective lens 111 or the XY stage 112 in the X direction and the Y direction. By moving the objective lens 111 or the XY stage 112, any position of the sample 113 can be irradiated with the energy beam 500 and the probe light 501, and a distribution of the absorption spectrum on the surface of the sample 113 can be measured. In particular, by performing measurement using the two confocal detectors while moving the objective lens 111 or the XY stage 112 in a state where the wavelength of the energy beam 500 is fixed, a map image of absorbance with respect to the wavelength can be generated.

The focus shift amount calculation unit 307 and the XY scanning control unit 308 are operated in cooperation with each other, so that the lens or the stage can be moved while making the focus of the probe light 501 following the unevenness of the surface of the sample 113. As a result, it is possible to perform XY scanning while constantly maintaining high detection sensitivity of the energy absorption rate.

A measurement result is output from the control device 300 to the outside. The absorption spectrum and the Raman spectrum may be output to the outside in a table format or a graph format, and the absorbance map image may be output to the outside in a graph format. The form of the output to the outside is optional, and includes display on a display device, storage in a storage device, printing by a printer, and the like.

As described above, the spectrometry device using the probe light shown in FIG. 1 can perform an infrared spectroscopic analysis with high spatial resolution and high detection sensitivity by detecting a change in a physical property value such as expansion of the sample 113 to which energy is applied, by using infrared rays or the like based on the outputs PD1 and PD2 of the two confocal detectors. Further, by detecting the Raman scattered light of the probe light using a spectrometer, the Raman spectroscopic analysis can be performed at the same time with the infrared spectroscopic analysis with the same spatial resolution as the infrared spectroscopic analysis.

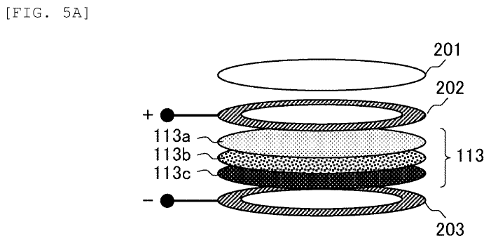

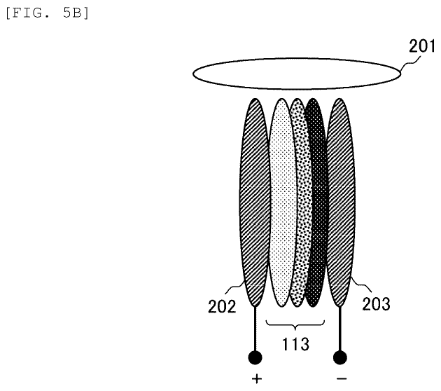

As shown in FIG. 2, the sample 113 is sealed in the cell 200 and is isolated from the atmospheric environment. FIG. 2 shows an example in which the cell 200 is an electrochemical cell, and a predetermined voltage can be applied to the cell 200. Accordingly, for example, when the sample 113 is a lithium ion battery material, a change in the material due to an electrochemical action during charging and discharging of the battery can be In-situ measured by the spectrometry device. An internal structure of the electrochemical cell will be described with reference to FIG. 5A. The sample 113 is a lithium ion battery material. A predetermined voltage can be applied to the sample 113 by interposing the sample 113 between a positive electrode 202 and a negative electrode 203. The sample (lithium ion battery material) 113 has a three-layer structure of a positive electrode material 113a, a separator 113b, and a negative electrode material 113c. In the example shown in FIG. 5A, the positive electrode 202 has a ring shape, and a surface of the positive electrode material 113a can be irradiated with the energy beam 500 and the probe light 501 through the observation window 201. A mesh-like electrode may be used as the electrodes 202 and 203. By reversing a positional relationship between the positive electrode 202 and the negative electrode 203, a surface of the negative electrode material 113c can be irradiated with the energy beam 500 and the probe light 501.

Further, a positional relationship among the electrodes 202 and 203, the sample 113, and the observation window 201 may be changed. FIG. 5B shows an example in which the sample 113 is arranged such that a stacking direction of materials in the sample 113 is orthogonal to optical axis directions of the energy beam 500 and the probe light 501. In this case, a cross-section of the sample 113 formed by stacking the materials can be In-situ measured, and the electrodes 202 and 203 may not have a ring shape. The cell 200 may not be an electrochemical cell. For the purpose of preventing deterioration by preventing the sample 113 from being exposed to the atmosphere, it is possible to use a cell having only a function of isolating the sample 113 from the atmospheric environment without including an electrode.

Here, the observation window 201 needs to transmit both the energy beam 500 and the probe light 501 to emit the energy beam 500 and the probe light 501 to the sample 113. Therefore, it is necessary to use a material exhibiting good light transmission characteristics in a wide wavelength band as a material of the observation window 201. Examples of suitable materials include calcium fluoride (CaF₂) and diamond.

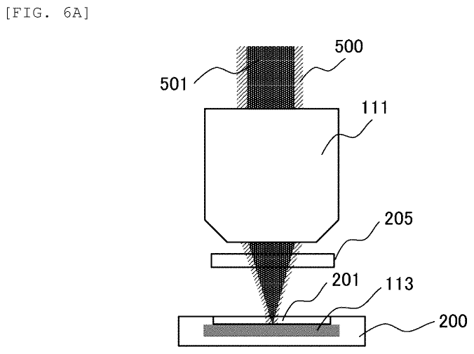

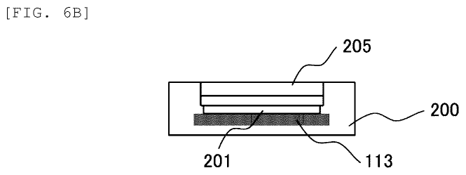

However, when the energy beam 500 and the probe light 501 are transmitted through the observation window 201, wavefront aberration is generated in the energy beam 500 and the probe light 501, and the spatial resolution is reduced on the surface of the sample 113, particularly by increasing the beam diameter of the probe light 501. In order to prevent the reduction in the spatial resolution, it is desirable to provide an aberration correction plate that cancels out the wavefront aberration caused by the observation window 201 in the optical system. FIG. 6A shows a configuration example in which an aberration correction plate 205 is attached to the objective lens 111. In the configuration example, even when measurement is performed while moving the objective lens 111 or the XY stage 112, a relative position between the objective lens 111 and the aberration correction plate 205 does not change, and thus aberration correction can be stably performed. As shown in FIG. 6B, the aberration correction plate 205 may be attached to the cell 200.

The embodiment of the invention has been described above. The invention is not limited to the embodiments described above, and components may be modified or the embodiments may be appropriately combined without departing from the gist of the invention. Further, some components may be deleted from all the components disclosed in the embodiments described above.

### REFERENCE SIGNS LIST

100: energy source
101, 102: beam expander lens
103: partial reflection mirror
104: energy detector
110: dichroic mirror
111: objective lens
112: XY stage
113: sample
113a: positive electrode material
113b: separator
113c: negative electrode material
120: light source
121: collimator lens
122: beam splitter
123: wavelength filter
124: condensing lens
125: half mirror
126, 128: pinhole
127, 129: light detector
130: dichroic mirror
132: spectrometer
200: cell
201: observation window
202: positive electrode
203: negative electrode
205: aberration correction plate
300: control device
301: overall control unit
302: energy source control unit
303: lock-in detection unit
304: probe light amount correction unit
305: spectrometer control unit
306: energy intensity correction unit
307: focus shift amount calculation unit
308: XY scanning control unit
500: energy beam
501: probe light

1. A spectrometry device comprising:
a stage configured to allow a sample to be placed;
a first electromagnetic wave source configured to generate a first electromagnetic wave;
a second electromagnetic wave source configured to generate a second electromagnetic wave having a wavelength shorter than the first electromagnetic wave;
an optical system including an objective lens configured to focus the first electromagnetic wave and the second electromagnetic wave on the sample;
a first detection unit configured to detect an electromagnetic wave having the same wavelength as the second electromagnetic wave and a second detection unit configured to detect an electromagnetic wave having a different wavelength from the second electromagnetic wave, among electromagnetic waves generated by reflection or scattering of the second electromagnetic wave by the sample;
a cell configured to separate the sample from an atmospheric environment to allow the sample to be placed on the stage; and
a control device configured to perform a first analysis based on a detection signal of the first detection unit and a second analysis based on a detection signal of the second detection unit.

2. The spectrometry device according to claim 1, wherein
the first electromagnetic wave is infrared light, and the second electromagnetic wave is visible light or ultraviolet light, and
the first analysis is an infrared spectroscopic analysis, and the second analysis is a Raman spectroscopic analysis.

3. The spectrometry device according to claim 1, wherein
the first detection unit includes a condensing lens, a first confocal detector, and a second confocal detector,
the second detection unit includes a spectrometer,
the first confocal detector includes a first light detector and a first pinhole that limits an amount of light incident on the first light detector,
the second confocal detector includes a second light detector and a second pinhole that limits an amount of light incident on the second light detector, the first pinhole is disposed at a position away from a focus position of the condensing lens by a predetermined distance in a direction approaching the first light detector along an optical axis of the condensing lens, and
the second pinhole is disposed at a position away from the focus position of the condensing lens by a predetermined distance in a direction away from the second light detector along an optical axis of the condensing lens.

4. The spectrometry device according to claim 1, wherein
the cell includes an observation window that transmits the first electromagnetic wave and the second electromagnetic wave, and
a material of the observation window is calcium fluoride or diamond.

5. The spectrometry device according to claim 4, wherein
the cell is an electrochemical cell including first and second electrodes that apply a voltage to the sample.

6. The spectrometry device according to claim 4, comprising:
an aberration correction plate that cancels out wavefront aberration caused by the observation window.

7. The spectrometry device according to claim 6, wherein
the aberration correction plate is attached to the objective lens.

8. A method for measuring a sample using a spectrometry device, wherein
the sample is a battery material having a stacked structure including a positive electrode material, a separator, and a negative electrode material, and
the spectrometry device includes a stage configured to allow a sample to be placed, a first electromagnetic wave source configured to generate a first electromagnetic wave, a second electromagnetic wave source configured to generate a second electromagnetic wave having a wavelength shorter than the first electromagnetic wave, an optical system including an objective lens configured to focus the first electromagnetic wave and the second electromagnetic wave on the sample, a first detection unit configured to detect an electromagnetic wave having the same wavelength as the second electromagnetic wave and a second detection unit configured to detect an electromagnetic wave having a different wavelength from the second electromagnetic wave, among electromagnetic waves generated by reflection or scattering of the second electromagnetic wave by the sample, a cell configured to separate the sample from an atmospheric environment to allow the sample to be placed on the stage and including a first electrode and a second electrode that apply a voltage to the sample, and a control device configured to perform a first analysis based on a detection signal of the first detection unit and a second analysis based on a detection signal of the second detection unit,
the method comprising:
sealing the sample in the cell in a state where the first electrode is in contact with the positive electrode material and the second electrode is in contact with the negative electrode material; and
irradiating the sample with the first electromagnetic wave and the second electromagnetic wave in a state where a predetermined voltage is applied to the sample to in-situ measure a change in the sample during charging and discharging of a battery.
